(19) United States
(12) Patent Application Publication
(10) Pub. No.: US 2017/0157680 A1
(43) Pub. Date: Jun. 8, 2017

(54) MODEL VEHICLE DRILL JIG

(71) Applicant: Martin Benning, Edmond, OK (US)

(72) Inventor: Martin Benning, Edmond, OK (US)

(21) Appl. No.: 14/956,687

(22) Filed: Dec. 2, 2015

(51) Int. Cl. B23B 49/02; A63H 17/26; A63H 17/00

(52) U.S. Cl. CPC B23B 49/02; A63H 17/002; A63H 17/26

(57) ABSTRACT

This application relates generally to a tool for drilling weight placement holes in a model car block or finished model car. The tool has a first segment and a second segment. The second segment extends from the first segment and has at least one hole extending through the second segment for drilling a least one weight placement hole into the model car block or the finished model car.

### FIELD OF THE INVENTION

The present disclosure relates generally to a tool for use in connection with model vehicles.

### BACKGROUND

Racing Pinewood Derby® model cars is a popular sport enjoyed by children and adults alike. Pinewood Derby® races are typically won by fractions of a second. Arguably, the two most important aspects to maximize model car speed relate to the reduction of friction and precision weight placement.

According to official Pinewood Derby® standards, each model car must weigh no more than 5 ounces in total. Normally, racers try to maximize their model car weight and modify the center of gravity to between 1″-1.5″ in front of the rear axle by placing weight at certain locations on the model vehicle.

Tungsten is the perferred weight used by serious racers because tungsten is 1.7 times heavier that lead and can be precisely placed for properly modifing the model car's center of gravity. Tungsten cylinders that are ⅜″ in diameter and in varying lengths are commonly used in Pinewood Derby® model cars and are readily available to racers.

Many parents and guardians to young Pinewood Derby® racers do not have a drill press to accurately drill weight placement holes and are left to do the best they can with a hand held drill. Even with best efforts, holes drilled without a press or jig are often unevenly spaced and angled in a manner that was not intended. In addition, many racers like to cut their cars to a very thin profile to increase aerodynamics. The thinner the car profile the more difficult it becomes to find space to place extra weight such as a tungsten cylinder. Thus, there is a need for a hand held jig or tool that eliminates the need for a drill press while delivering perfectly spaced weight placement holes at the exact angle intended.

### BRIEF DESCRIPTION OF THE DRAWINGS

FIG. 1 is a top view of one embodiment of the tool disclosed herein.

FIG. 2 is a side view of the tool in FIG. 1 depicting the forward surface side of the tool.

FIG. 3 is an end view of the tool in FIG. 1 depicting the top segment side of the tool.

FIG. 4 is a top view of one of the embodiment of the tool disclosed herein.

FIG. 5 is a side view of the tool in FIG. 4 depicting the rear surface side of the tool.

FIG. 6 is an end view of the tool in FIG. 4 depicting the center segment side of the tool.

FIG. 7 is a top view of one of the embodiments of the tool disclosed herein.

FIG. 8 is a side view of the tool in FIG. 7 depicting the rear surface side of the tool.

FIG. 9 is an end view of the tool in FIG. 7 depicting the center segment side of the tool.

FIG. 10 is a top view of one of the embodiments of the tool disclosed herein.

FIG. 11 is a side view of the tool in FIG. 10 depicting the forward surface side of the tool.

FIG. 12 is an end view of the tool in FIG. 10 depicting the bottom segment side of the tool.

FIG. 13 is a top view of one of the embodiments of the tool disclosed herein.

FIG. 14 is a side view of the tool in FIG. 13 depicting the forward surface side of the tool.

FIG. 15 is an end view of the tool in FIG. 13 depicting the center segment side of the tool.

FIG. 16 is a top view of one of the embodiments of the tool disclosed herein.

FIG. 17 is a side view of the tool in FIG. 16 depicting the forward surface side of the tool.

FIG. 18 is an end view of the tool in FIG. 16 depicting the bottom segment side of the tool.

FIG. 19 is a top view of one embodiment assembled to a model car block.

FIG. 20 is a side view of the assembly in FIG. 19 depicting the bottom segment side of the tool.

FIG. 21 is a top view of one embodiment assembled to a finished model car.

FIG. 22 is a side view of the assembly in FIG. 21 depicting the top segment side of the tool.

### DETAILED DESCRIPTION

The present disclosure covers a drill guide jig or tool. The tool can be made of aluminum, a metal, plastic or some other material. The jig can be used by any user, for example a cub scout, parent or an adult supervisor (the “builder”) for the purpose of drilling weight placement holes in a model car block or finished model car.

The tool is designed to fit onto a standard Pinewood Derby® model car block and aid in the precision placement of weight placement holes so that the builder can more easily create the correct center of gravity. The tool can also be clamped in place before drilling as detailed below. The weight placement holes are precision sized for use with a conventional drill bit which will perfectly accommodate weighted cylinders used by racers, such as tungsten cylinders.

Another feature of this tool is the ability to drill weight placement holes on an angle. The tool will allow the user to drill at an angle into the rear of the finished model car and allow weight to be placed at a more forward location in the model car without affecting aerodynamics. Lastly, the drill guides or holes in the tool allow the builder to perfectly balance the horizontal weight distribution of the model car to aid in straight tracking down the track.

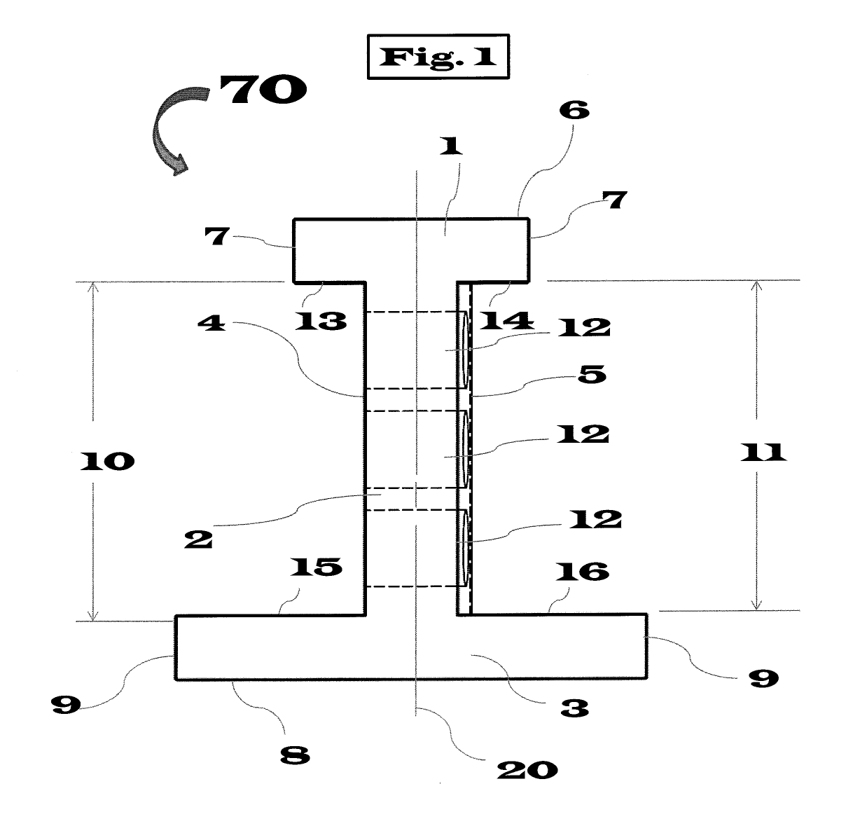

FIGS. 1-3 illustrate and generally designate a tool by the numeral 70. The preferred embodiment of tool 70 has a center segment (second segment) 2 that is generally rectangular in shape and has non parallel sides—a forward surface (first surface) 4 and a rear surface (second surface) 5. Center segment 2 connects to a top segment (first segment) 1 and a bottom segment (third segment) 3.

Top segment 1 is generally rectangular in shape and is perpendicular to a longitudinal axis 20 of center segment 2. Longitudinal axis 20 is centered about center segment 2. Top segment 1 has a top surface 6, bottom surfaces 13 and 14 and mutually parallel ends 7.

Bottom segment 3 is generally rectangular in shape and perpendicular to a longitudinal axis 20 of center segment 2. Bottom segment 3 has a bottom surface 8, top surfaces 15 and 16 and mutually parallel ends 9.

Center segment 2 is located between and connected to top segment 1 and bottom segment 3. Top segment 1 and bottom segment 3 extend from the center segment 2 such that a first channel 10 and a second channel 11 are formed.

First channel 10 is located between bottom surface 13 and top surface 15. In some embodiments, first channel 10 is designed to receive a top 51, bottom 52, sides 55/56, rear end 53 or front end 54 of a model car block 50 to aid in drilling straight weight placement holes 30 into those surfaces. In other embodiments, first channel 10 is designed to receive a top 61, bottom 62, sides 65/66, rear end 63 or front end 64 of a finished model car 60 to aid in drilling straight weight placement holes 30 into those surfaces. For example, in a specific embodiment, the distance between bottom surface 13 and top surface 15 is 1.75″ corresponding to the standard nominal width (rear end 53/front end 54) of model car block 50.

Second channel 11 is located between bottom surface 14 and top surface 16. In some embodiments, second channel 11 is designed to receive a top 51, bottom 52, sides 55/56, rear end 53 or front end 54 surface of a model car block 50 to aid in drilling angled weight placement holes 30 into those surfaces. In other embodiments, second channel 11 is designed to receive a top 61, bottom 62, sides 65/66, rear end 63 or front end 64 surface of a finished model car block 60 to aid in drilling angled weight placement holes 30 into those surfaces. For example, in a specific embodiment, the distance between bottom surface 14 and top surface 16 is 1.75″ corresponding to the standard nominal width (rear end 63/font end 64) of finished model car 60.

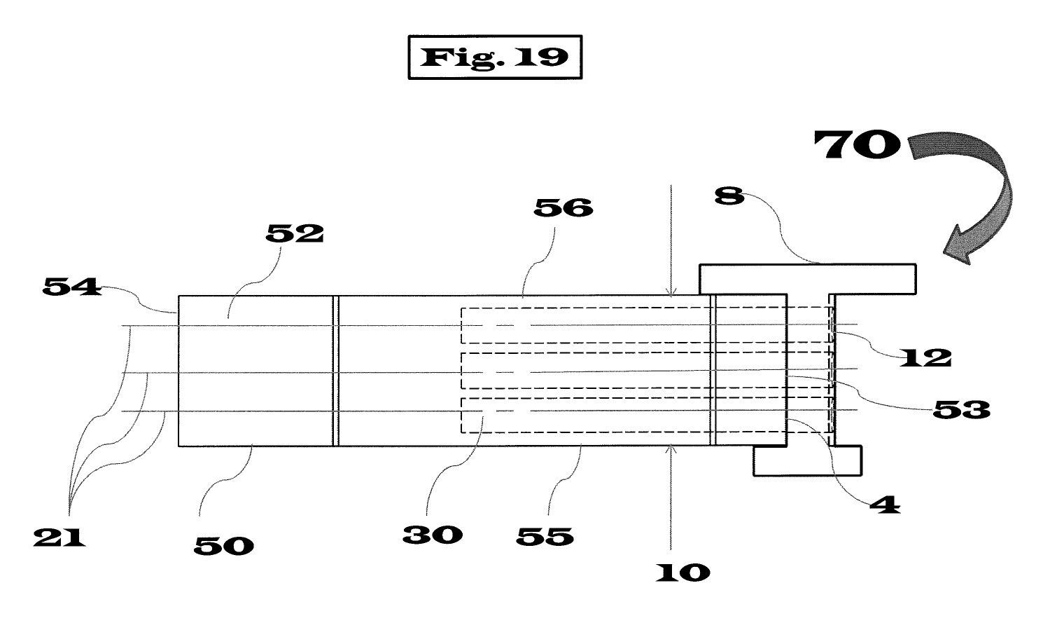

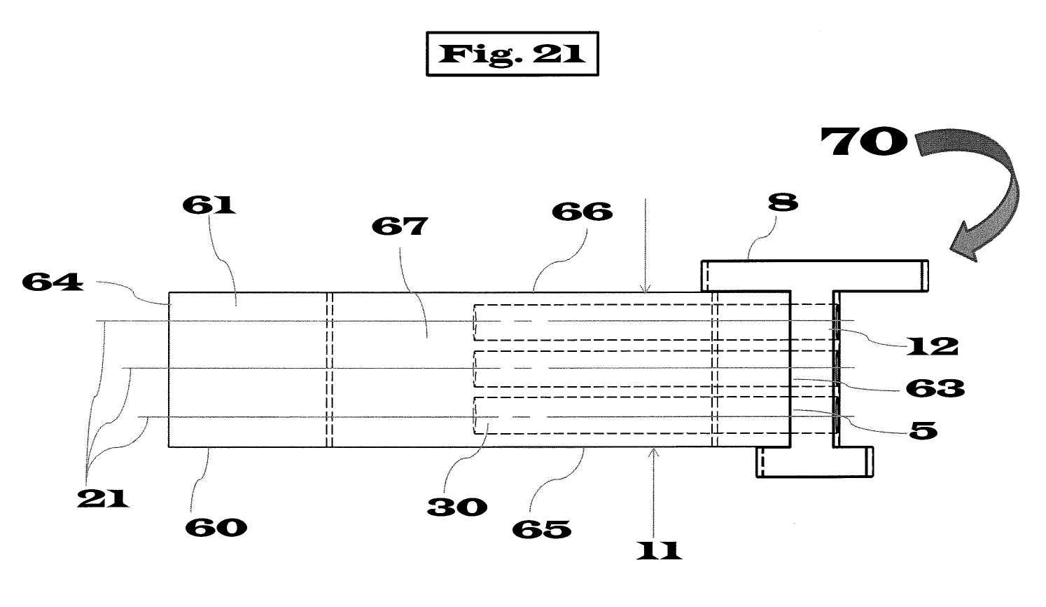

In some embodiments, top segment 1 is equidistantly shorter between end 7 than bottom segment 3. For example, top segment 1 can be equidistantly shorter than bottom segment 3 by about 5% to about 70%. In some embodiments, top segment 1 can be equidistantly shorter than bottom segment 3 by about 20% to about 50%. The shorter length allows for clamping of tool 70 onto model car block 50 or finished model car 60 to allow strategic placement of the tool 70 and prevent unwanted movement during drilling. For example, FIG. 19 depicts model car block 50 correctly positioned within first channel 10 of tool 70 such that a clamp (not shown) may engage top surface 8 of tool 70 and a surface 55 of model car block 50. In another example, FIG. 21 depicts finished model car 60 correctly position within second channel 11 of tool 70 such that a clamp (not shown) may engage top surface 8 of tool 70 and a surface 65 of model car block 50.

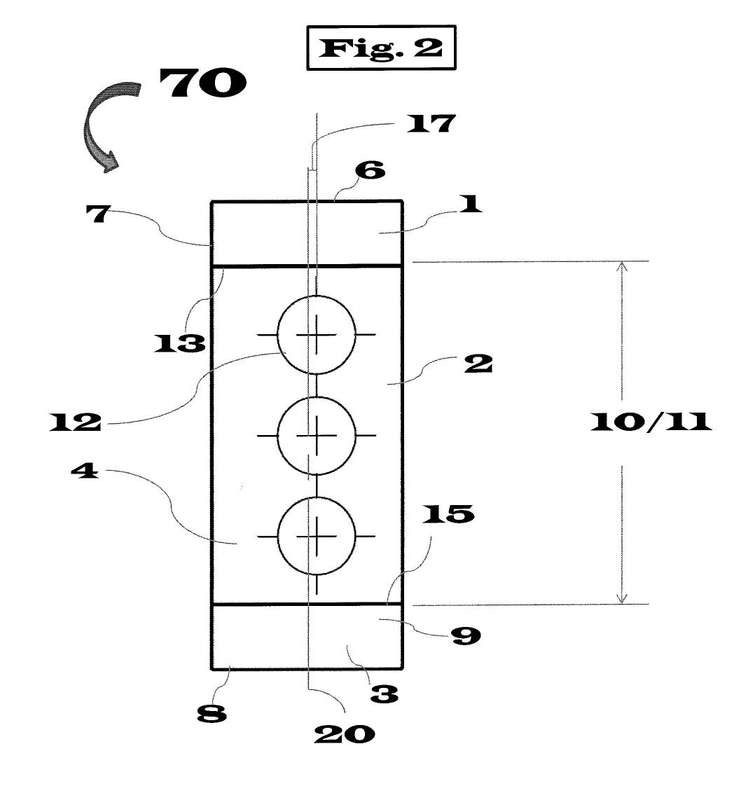

Referring now to FIG. 2, spaced cylindrical holes 12 extend through the center segment 2 between forward surface 4 and rear surface 5 of tool 70. Holes 12 are perpendicular to longitudinal axis 20. In some embodiments, there can be one or more holes, equally or unequally spaced from one another. In other embodiments, the holes 12 may align vertically along the longitudinal axis 20. In still other embodiments the holes 12 may have an offset 17 from the longitudinal axis 20 in either direction. For example, offset 17 from the longitudinal axis 20 can be from about 0.01″ to about 0.11″. More preferably, offset 17 can be from about 0.03″ to about 0.05″. The diameter of holes 12 is dictated by the purpose of the hole to be drilled. For example, to drill weight placement holes to fit a tungsten cylinder ⅜″ diameter, holes 12 would have a diameter of 0.406″ for use with a 25/64″ drill bit.

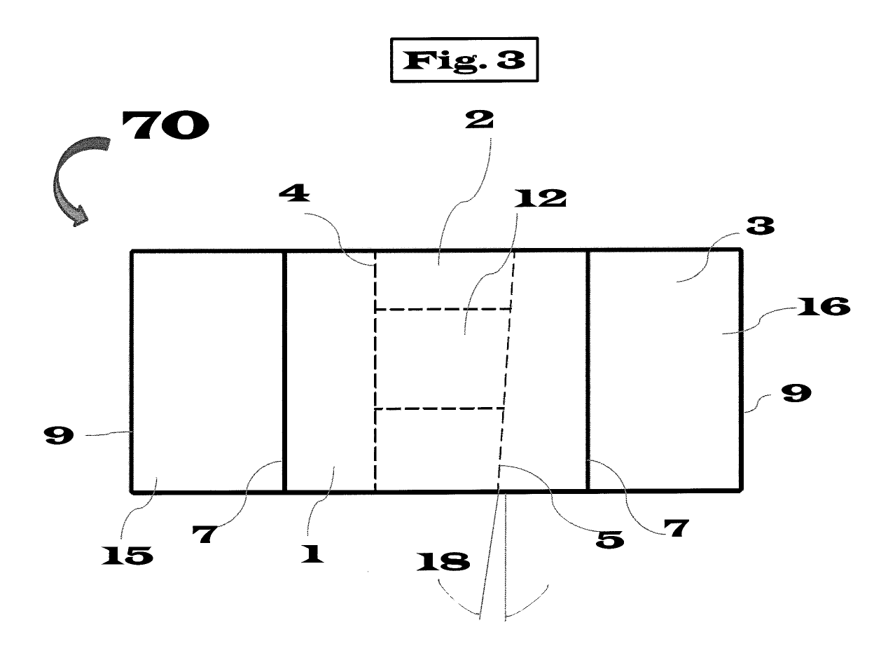

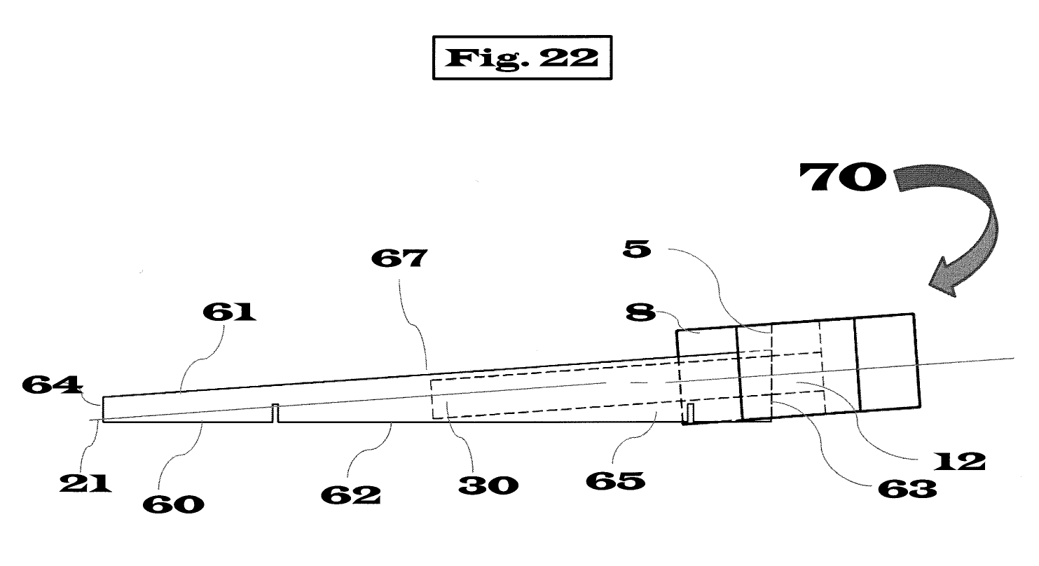

FIG. 3 is an end view of tool 70. As shown in FIG. 3, holes 12 of tool 70 are perpendicular with forward surface 4. Forward surface 4 is parallel with ends 9 and 7. In some embodiments, rear surface 5 may also be parallel with forward surface 4 and ends 9 and 7. In other embodiments, rear surface 5 is angled as indicated by angle 18. Angle 18 is an angle formed between rear surface 5 and a plane parallel with forward surface 4. Angle 18 of rear surface 5 can be about 1 degree, 2 degrees, 3 degrees, 4 degrees, 5 degrees, 6 degrees, 7 degrees, 8 degrees, 9 degrees or 10 degrees from a vertical plane, such as end 7. Preferably, angle 18 of rear surface 5 is within the range of 3 degrees to 5 degrees. If rear surface 5 is angled, weight placement holes 30 drilled into a surface of model car block 50 (or finished model car 60) when the rear face 5 engages model car block 50 are drilled at a different angle than weight placement holes 30 drilled into a surface of model car block 50 (or finished model car 60) when the forward face 4 engages model car block 50 (or finished model car 60). As shown in FIG. 22, weight placement holes 30 drilled when rear surface 5 engages a surface of finished model car 60 have central axes 21 substantially parallel with a top surface 67 of finished model car 60. FIG. 22 also depicts central axes 21 of weight placement holes 30 can form an angle with a horizontal plane, such as a bottom surface 62 of finished model car 60.

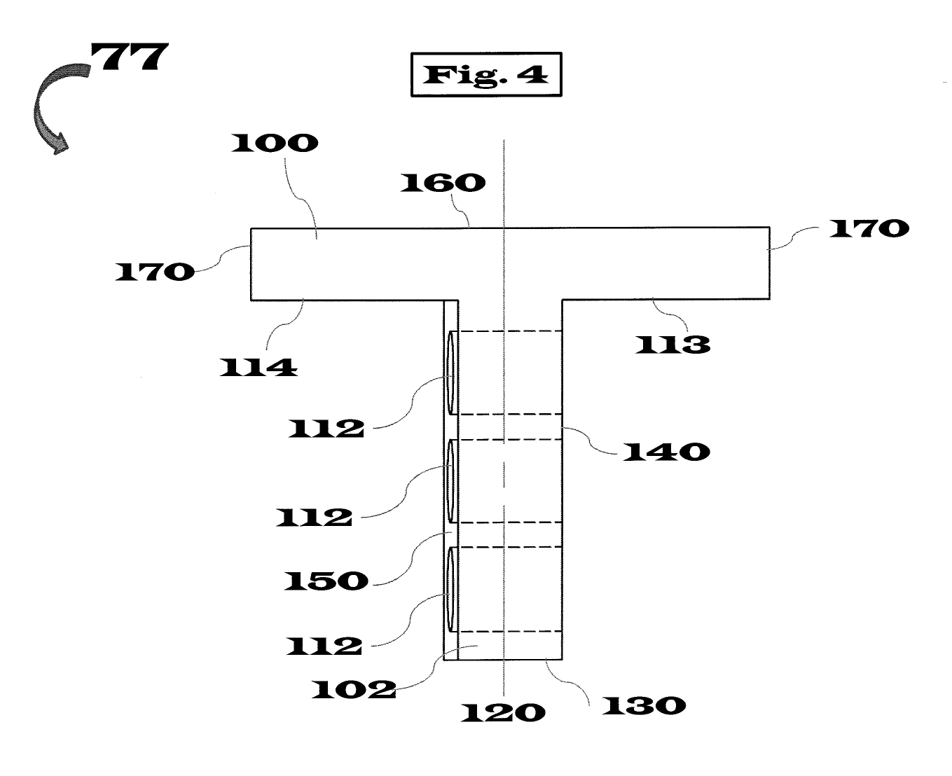

FIGS. 4-6 illustrate and generally designate another embodiment of a tool by the numeral 77. As shown in FIG. 4, tool 77 has a center segment (second segment) 102 that is generally rectangular in shape and has non-parallel sides—a forward surface (first surface) 140, a rear surface (second surface) 150 and a lower surface 130. Center segment 102 connects to a top segment (first segment) 100.

Top segment 100 is generally rectangular in shape and is perpendicular to a longitudinal axis 120 of center segment 102. Longitudinal axis 120 is centered about center segment 102. Top Segment 100 has a top surface 160, bottom surfaces 114 and 113 and mutually parallel ends 170.

Cylindrical holes 112 extend through the center segment 102 between forward surface 140 and rear surface 150. Holes 112 can be equally or unequally spaced between the bottom surfaces 114 and 113 and lower surface 130. Holes 112 extend through center segment 102 and are perpendicular to longitudinal axis 120.

Bottom surface 113 and forward surface 140, being coplanar, form a right angle and simultaneously contact any side of model car block 50 or finished model car 60 to aid in drilling straight weight placement holes 30.

Bottom surface 114 and forward surface 140, being coplanar, form a right angle and simultaneously contact any side of model car block 50 or finished model car 60 to aid in drilling angled weight placement holes 30.

In one embodiment, forward surface 140 and rear surface 150 each measure 1.75″ between bottom surfaces 113/114 and lower surface 130 to engage a surface of model car block 50.

In one embodiment, top surface 160 of top segment 100 can be used to clamp tool 77 into place using a surface of model car block 50 as the other clamping surface. A clamp will hold tool 77 rigidly in place while drilling weight placement holes 30 into the model car block 50.

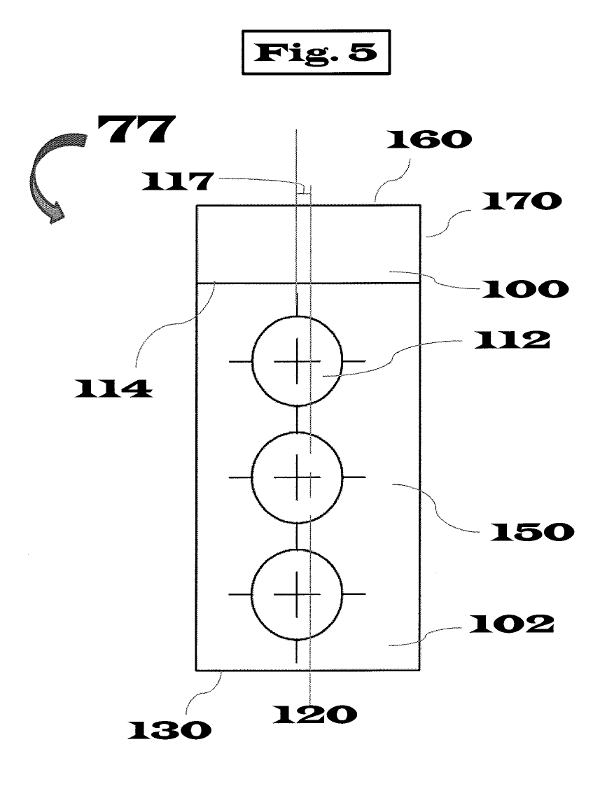

FIG. 5 is a side view of tool 77. In one embodiment, holes 112 extending through the center segment 102 and align vertically along the longitudinal axis 120. In another embodiment, holes 112 are offset from the longitudinal axis 120. In still other embodiments the holes 112 may have an offset 117 from the longitudinal axis 120 in either direction. For example, offset 117 from the longitudinal axis 120 can be from about 0.01″ to about 0.11″. More preferably, offset 117 can be from about 0.03″ to about 0.05″. The diameter of holes 112 is dictated by the purpose of the hole to be drilled. For example, to drill weight placement holes to fit a tungsten cylinder ⅜″ diameter, holes 112 would have a diameter of 0.406″ for use with a 25/64″ drill bit.

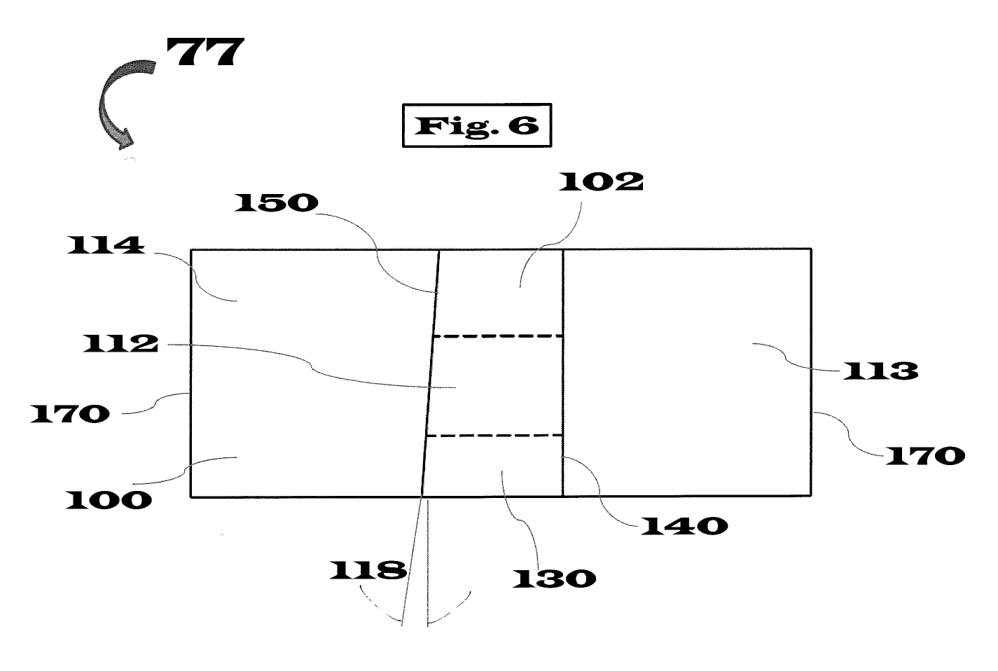

FIG. 6 is an end view of tool 77. As shown in FIG. 6, holes 112 of tool 77 are perpendicular with forward surface 140. Forward surface 140 is parallel with ends 170. In some embodiments, rear surface 150 may also be parallel with forward surface 140 and ends 170. In other embodiments, rear surface 150 is angled as indicated by angle 118. Angle 118 is an angle formed between rear surface 150 and a plane parallel with forward surface 140. Angle 118 of rear surface 150 can be about 1 degree, 2 degrees, 3 degrees, 4 degrees, 5 degrees, 6 degrees, 7 degrees, 8 degrees, 9 degrees or 10 degrees from a vertical plane, such as end 170. Preferably, angle 118 of rear surface 150 is within the range of about 3 degrees to about 5 degrees. If rear surface 150 is angled, weight placement holes 30 drilled into a surface of model car block 50 (or finished model car 60) when the rear face 150 engages model car block 50 are drilled at a different angle than weight placement holes 30 drilled into a surface of model car block 50 (or finished model car 60) when the forward face 140 engages model car block 50 (or finished model car 60).

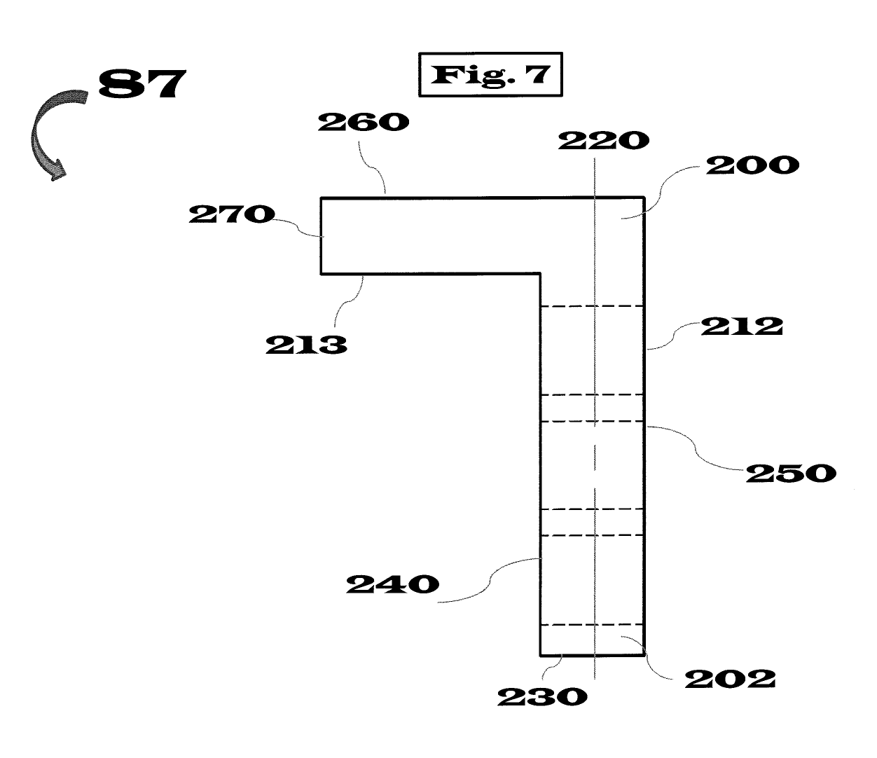

FIGS. 7-9 illustrate and generally designate another embodiment of a tool by the numeral 87. As shown in FIG. 7, tool 87 has a center segment (second segment) 202 that is generally rectangular in shape and has parallel sides—a forward surface (first surface) 240, a rear surface (second surface) 250 and a lower surface 230. Center segment 202 connects to a top segment (first segment) 200.

Top segment 200 is generally rectangular in shape and is perpendicular to a longitudinal axis 220 of center segment 202. Longitudinal axis 220 is centered about center segment 202. Top segment 200 has a top surface 260, a bottom surface 213 and an end 270 that's parallel with surfaces 250 and 240.

Cylindrical holes 212 extend through the center segment 202 between forward surface 240 and rear surface 250. Holes 212 can be equally or unequally spaced between the bottom surface 213 and lower surface 230. Holes 212 extend through center segment 202 and are perpendicular to longitudinal axis 220.

Bottom surface 213 and forward surface 240, being coplanar, form a right angle and simultaneously contact any side of model car block 50 or finished model car 60 to aid in drilling straight weight placement holes 30.

In one embodiment, forward surface 240 measures 1.75″ between bottom surface 213 and lower surface 230 to engage a surface of model car block 50.

In one embodiment, top surface 260 of top segment 200 can be used to clamp tool 87 into place using a surface of model car block 50 as the other clamping surface. A clamp will hold tool 87 rigidly in place while drilling weight placement holes 30 into the model car block 50.

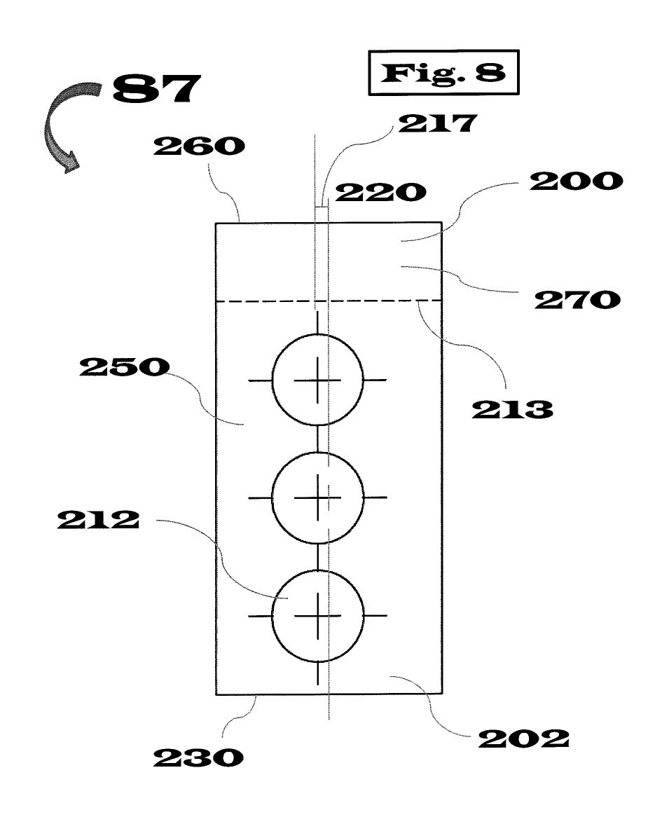

FIG. 8 is a side view of tool 87. In one embodiment, holes 212 extending through the center segment 202 align vertically along the longitudinal axis 220. In another embodiment, holes 212 are offset from the longitudinal axis 220. In still other embodiments the holes 212 may have an offset 217 from the longitudinal axis 220 in either direction. For example, offset 217 from the longitudinal axis 220 can be from about 0.01″ to about 0.11″. More preferably, offset 217 can be from about 0.03″ to about 0.05″. The diameter of holes 212 is dictated by the purpose of the hole to be drilled. For example, to drill weight placement holes to fit a tungsten cylinder ⅜″ diameter, holes 212 would have a diameter of 0.406″ for use with a 25/64″ drill bit.

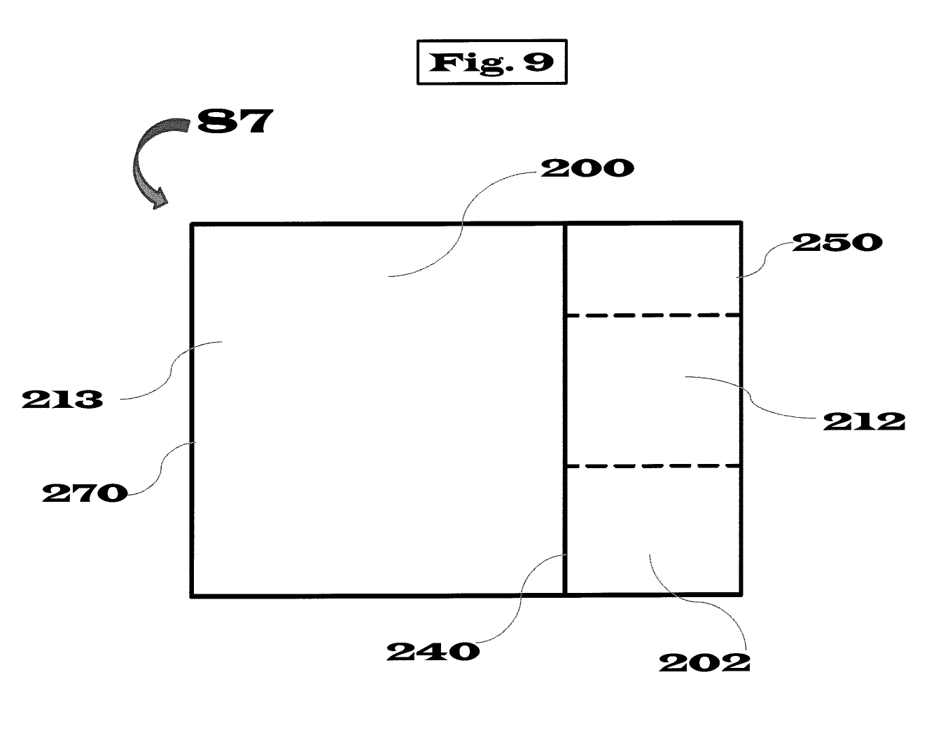

FIG. 9 is an end view of tool 87. As shown in FIG. 9, holes 212 of tool 87 are perpendicular with forward surface 240. Weight placement holes 30 drilled into a surface of model car block 50 (or finished model car 60) when the forward face 240 engages the model car block 50 (or finished model car 60) are drilled at a parallel or perpendicular angle to any surface of model car block 50 (or finished model car 60).

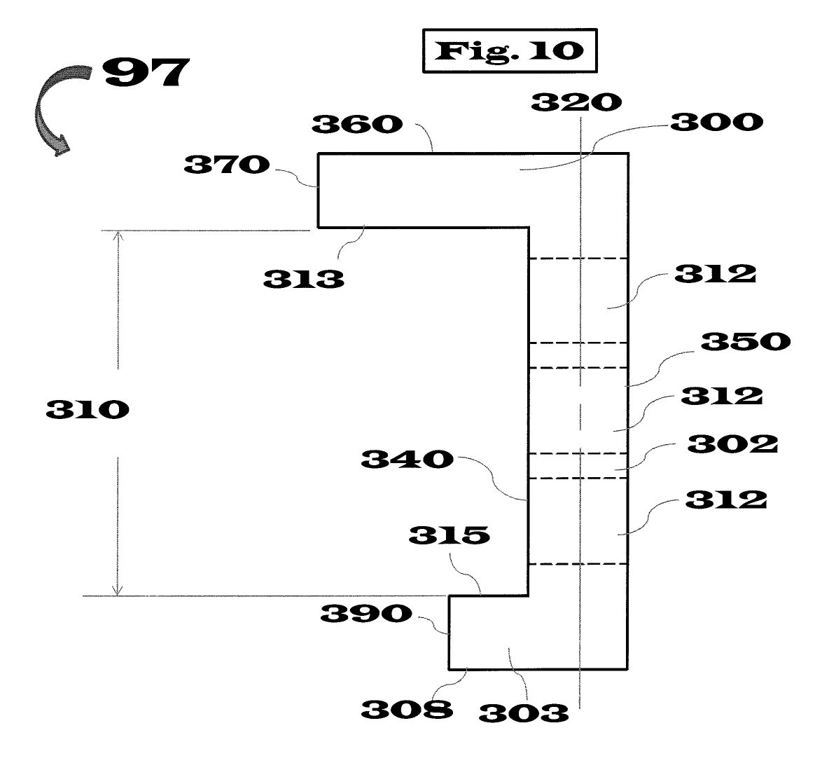

FIGS. 10-12 illustrate and generally designate another embodiment of a tool by the numeral 97. As shown in FIG. 10, tool 97 has a center segment (second segment) 302 that is generally rectangular in shape and has parallel sides—a forward surface (first surface) 340, a rear surface (second surface) 350. Center segment 302 connects to a top segment (first segment) 300 and a bottom segment (third segment) 303. Top segment 300 is generally rectangular in shape and is perpendicular to a longitudinal axis 320 of center segment 302. Longitudinal axis 320 is centered about center segment 302. Top Segment 300 has a top surface 360, a bottom surface 313 and an end 370 that's parallel with rear surface 350.

Bottom segment 303 is generally rectangular in shape and perpendicular to a longitudinal axis 320 of center segment 302. Bottom segment 303 has a bottom surface 308, a top surface 315 and an end 390 parallel with rear surface 350. Center segment 302 is located between top segment 300 and bottom segment 303.

Cylindrical holes 312 extend through the center segment 302 between forward surface 340 and rear surface 350. Holes 312 can be equally or unequally spaced between top segment 300 and bottom segment 303. Holes 312 extend through center segment 302 and are perpendicular to longitudinal axis 320.

First channel 310 is located between bottom surface 313 and top surface 315. In some embodiments, first channel 310 is designed to receive a top 51, bottom 52, sides 55/56, rear end 53 or front end 54 surface of a model car block 50 to aid in drilling straight weight placement holes 30 into those surfaces. In other embodiments, first channel 310 is designed to receive a top 61, bottom 62, sides 65/66, rear end 63 or front end 64 surface of a finished model car 60 to aid in drilling straight weight placement holes 30 into those surfaces. For example, in a specific embodiment, the distance between bottom surface 313 and top surface 315 is 1.75″ corresponding to the standard nominal width (rear end 53/front end 54) of model car block 50.

In some embodiments, top segment 300 is longer than bottom segment 303. For example, top segment 300 can be longer than bottom segment 303 by about 5% to about 70%. In other embodiments, top segment 300 is longer than bottom segment 303 by about 20% to about 50%. The longer length allows for clamping of tool 97 onto model car block 50 or finished model car 60 to allow strategic placement of the tool 97 and prevent unwanted movement during drilling.

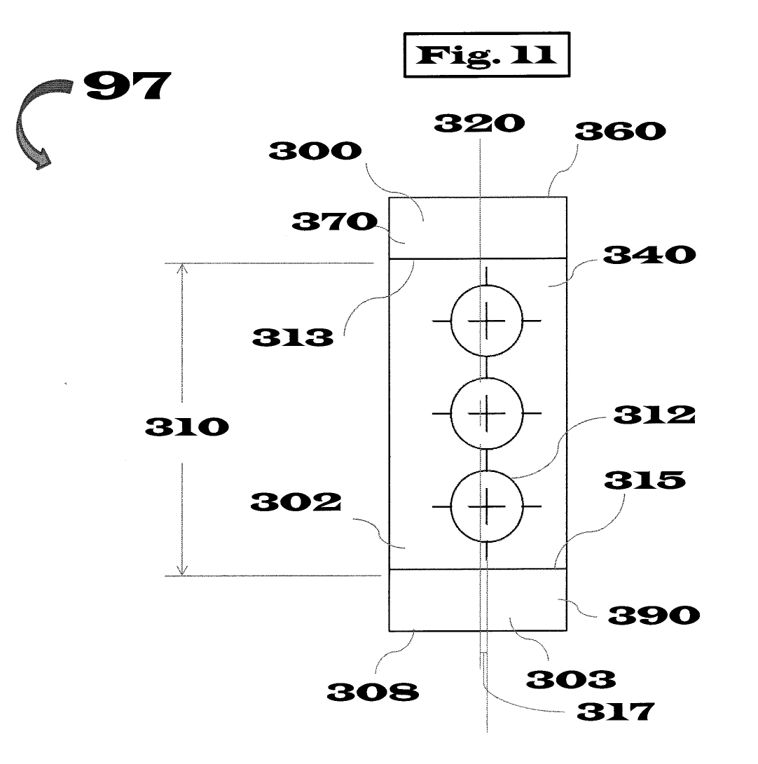

FIG. 11 is a side view of tool 97. In one embodiment, holes 312 extending through the center segment 302 align vertically along the longitudinal axis 320. In another embodiment, holes 312 are offset from the longitudinal axis 320. In still other embodiments the holes 312 may have an offset 317 from the longitudinal axis 320 in either direction. For example, offset 317 from the longitudinal axis 320 can be from about 0.01″ to about 0.11″. More preferably, offset 317 can be from about 0.03″ to about 0.05″. The diameter of holes 312 is dictated by the purpose of the hole to be drilled. For example, to drill weight placement holes to fit a tungsten cylinder ⅜″ diameter, holes 312 would have a diameter of 0.406″ for use with a 25/64″ drill bit.

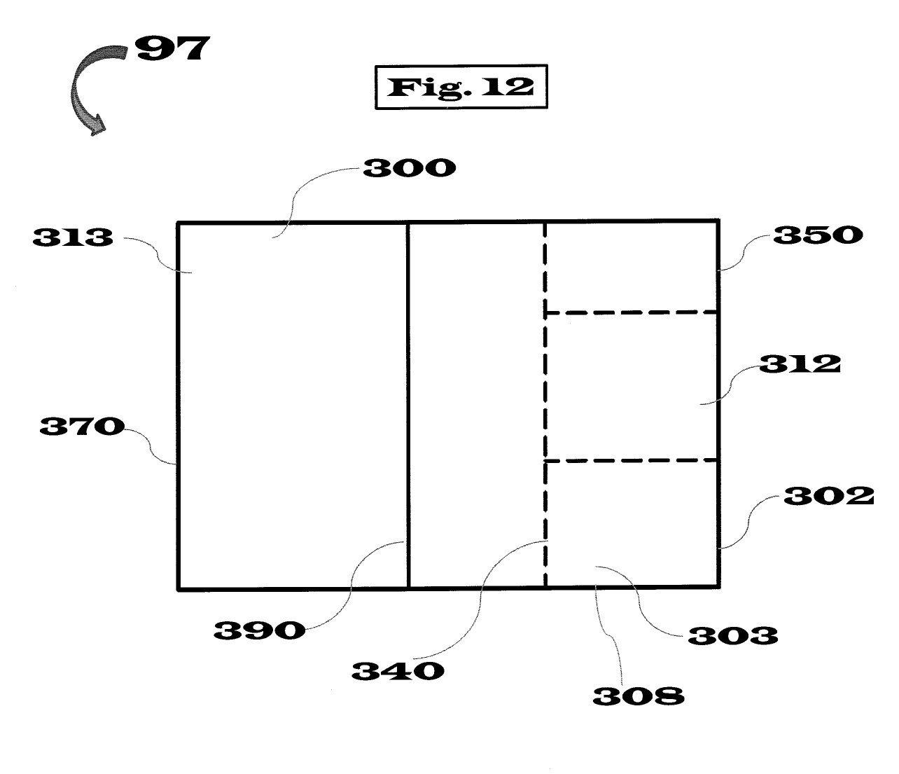

FIG. 12 is an end view of tool 97. As shown in FIG. 12, holes 312 of tool 97 are perpendicular with forward surface 340. Weight placement holes 30 drilled into a surface of model car block 50 when the forward face 340 engages the model car block 50 are drilled at a parallel or perpendicular angle to any surface of model car block 50.

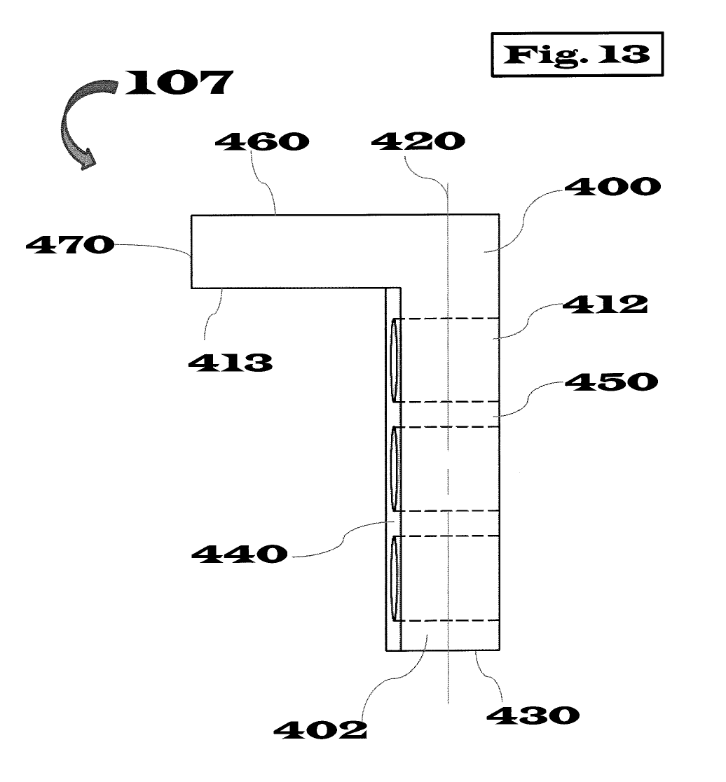

FIGS. 13-15 illustrate and generally designate another embodiment of a tool by the numeral 107. As shown in FIG. 13, tool 107 has a center segment (second segment) 402 that is generally rectangular in shape and has non-parallel sides—a forward surface (first surface) 440, a rear surface (second surface) 450 and a lower surface 430. Center segment 402 connects to a top segment (first segment) 400.

Top segment 400 is generally rectangular in shape and is perpendicular to a longitudinal axis 420 of center segment 402. Longitudinal axis 420 is centered about center segment 402. Top Segment 400 has a top surface 460, a bottom surface 413 and an end 470 that is parallel with rear surface 450.

Cylindrical holes 412 extend through the center segment 402 between forward surface 440 and rear surface 450. Holes 412 can be equally or unequally spaced between the bottom surface 413 and lower surface 430. Holes 412 extend through center segment 402 and are perpendicular to longitudinal axis 420.

Bottom surface 413 and forward surface 440, being coplanar, form a right angle and simultaneously contact any side of model car block 50 or finished model car 60 to aid in drilling angled weight placement holes 30.

Model car block 50 has a nominal dimension of 1.75″ across its width and 7″ across its length. In one embodiment, forward surface 440 measures 1.75″ between bottom surface 414 and lower surface 430 to engage a surface of model car block 50 or model car block 60.

In one embodiment, top surface 460 of top segment 400 can be used to clamp tool 107 into place using a surface of model car block 50 as the other clamping surface. A clamp will hold tool 107 rigidly in place while drilling weight placement holes 30 into the model car block 50.

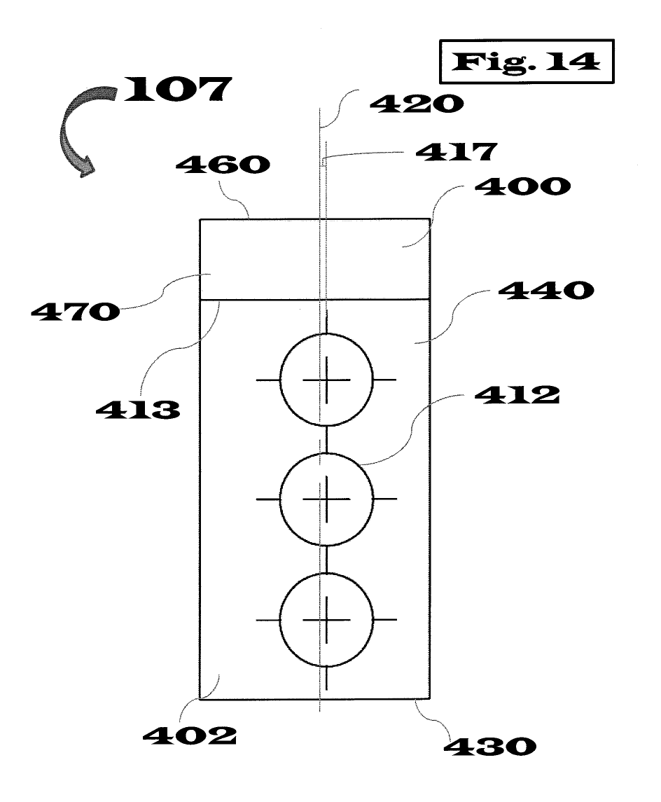

FIG. 14 is a side view of tool 107. In one embodiment, holes 412 extend through the center segment 402 and align vertically along the longitudinal axis 420. In another embodiment, holes 412 are offset from the longitudinal axis 420. In still other embodiments the holes 412 may have an offset 417 from the longitudinal axis 420 in either direction. For example, offset 417 from the longitudinal axis 420 can be from about 0.01″ to about 0.11″. More preferably, offset 417 can be from about 0.03″ to about 0.05″. The diameter of holes 412 is dictated by the purpose of the hole to be drilled. For example, to drill weight placement holes to fit a tungsten cylinder ⅜″ diameter, holes 412 would have a diameter of 0.406″ for use with a 25/64″ drill bit.

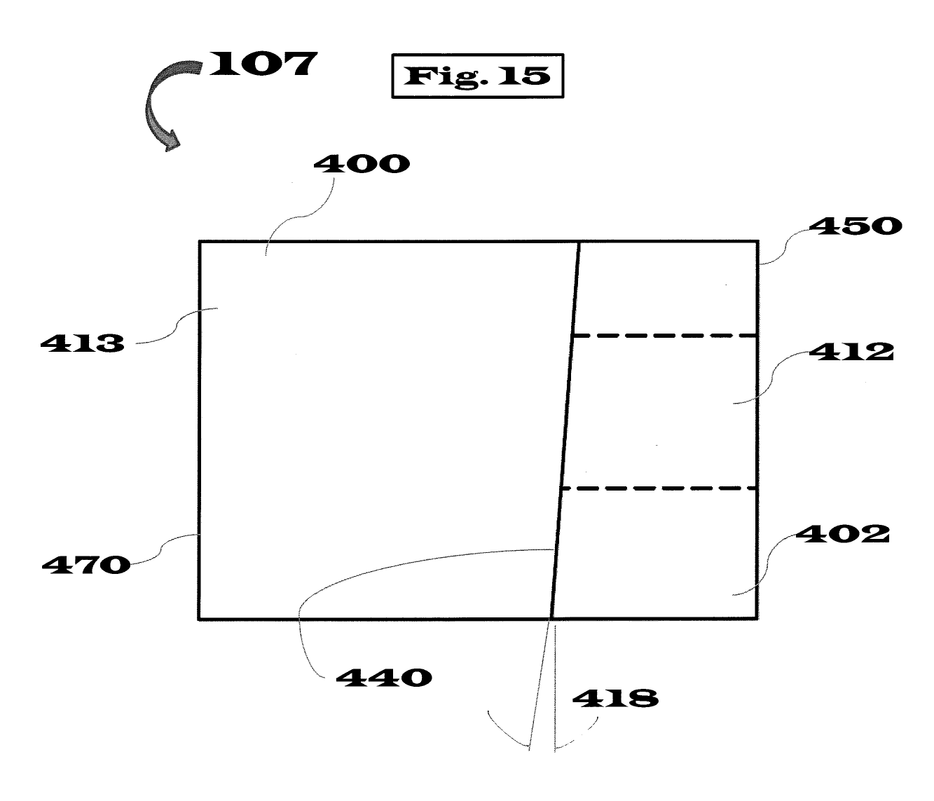

FIG. 15 is an end view of tool 107. As shown in FIG. 15, holes 412 of tool 107 are perpendicular with forward surface 450. Forward surface 450 is parallel with end 470. In some embodiments, rear surface 440 may also be parallel with forward surface 450 and end 470. In other embodiments, rear surface 440 is angled as indicated by angle 418. Angle 418 is an angle formed between rear surface 450 and a plane parallel with forward surface 440. Angle 418 of rear surface 440 can be about 1 degree, 2 degrees, 3 degrees, 4 degrees, 5 degrees, 6 degrees, 7 degrees, 8 degrees, 9 degrees or 10 degrees from a vertical plane, such as end 470. Preferably, angle 418 of rear surface 440 is within the range of about 3 degrees to about 5 degrees. If rear surface 440 is angled, weight placement holes 30 drilled into a surface of model car block 50 (or finished model car 60) when the rear face 440 engages model car block 50 are drilled at a different angle than weight placement holes 30 drilled into a surface of model car block 50 (or finished model car 60) when the forward face 450 engages model car block 50 (or finished model car 60).

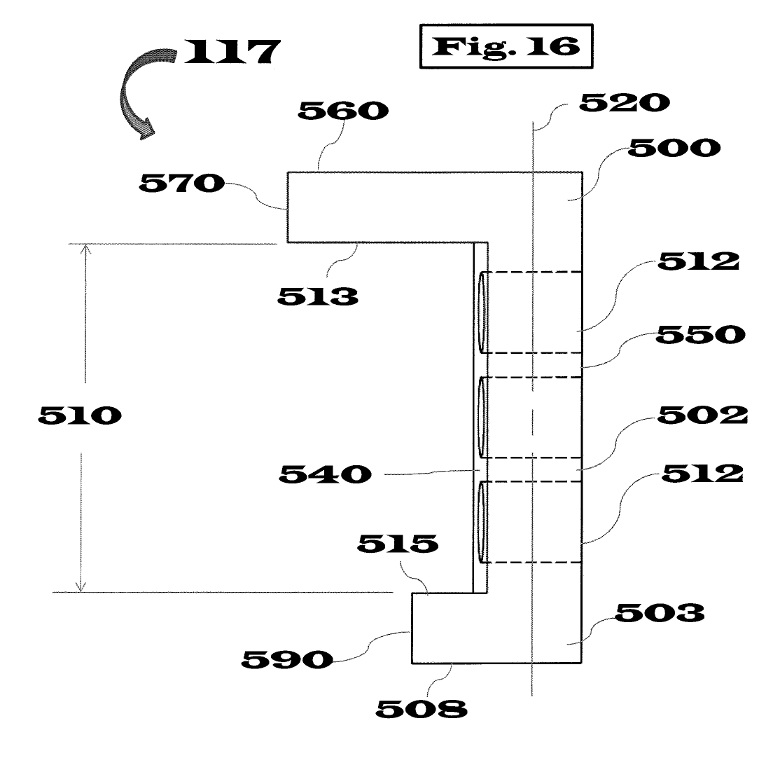

FIGS. 16-18 illustrate and generally designate another embodiment of a tool by the numeral 117. As shown in FIG. 16, tool 117 has a center segment (second segment) 502 that is generally rectangular in shape and has non-parallel sides—a forward surface (first surface) 540, a rear surface (second surface) 550. Center segment 502 connects to a top segment (first segment) 500 and a bottom segment (third segment) 503. Top segment 500 is generally rectangular in shape and is perpendicular to a longitudinal axis 520 of center segment 502. Longitudinal axis 520 is centered about center segment 502. Top Segment 500 has a top surface 560, a bottom surface 513 and an end 570 that's parallel with rear surface 550.

Bottom segment 503 is generally rectangular in shape and perpendicular to a longitudinal axis 520 of center segment 502. Bottom segment 503 has a bottom surface 508, a top surface 515 and an end 590 that's parallel with rear surface 550. Center segment 502 is located between top segment 500 and bottom segment 503.

Cylindrical holes 512 extend through the center segment 502 between forward surface 540 and rear surface 550. Holes 512 can be equally or unequally spaced between top segment 500 and bottom segment 503. Holes 512 extend through center segment 502 and are perpendicular to longitudinal axis 520. Holes 512 can be of any quantity between one and three. In other embodiments, there may be more than three holes 512.

First channel 510 is located between bottom surface 513 and top surface 515. In some embodiments, first channel 510 is designed to receive a top 51, bottom 52, sides 55/56, rear end 53 or front end 54 surface of a model car block 50 to aid in drilling angled weight placement holes 30 into those surfaces. In other embodiments, first channel 510 is designed to receive a top 61, bottom 62, sides 65/66, rear end 63 or front end 64 surface of a finished model car 60 to aid in drilling angled weight placement holes 30 into those surfaces. For example, in a specific embodiment, the distance between bottom surface 513 and top surface 515 is 1.75″ corresponding to the standard nominal width (rear end 53/front end 54) of model car block 50.

In some embodiments, top segment 500 is longer than bottom segment 503. For example, top segment 500 can be longer than bottom segment 503 by about 5% to about 70%. In other embodiments, top segment 500 is longer than bottom segment 503 by about 20% to about 50%. The longer length allows for clamping of tool 117 onto model car block 50 or finished model car 60 to allow strategic placement of the tool 117 and prevent unwanted movement during drilling.

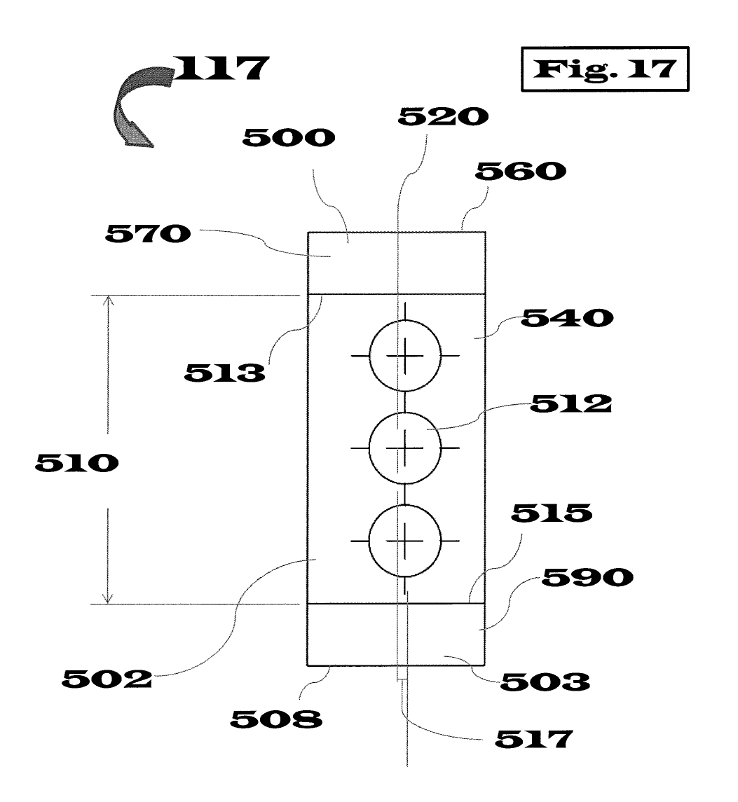

FIG. 17 is a side view of tool 117. In one embodiment, holes 512 extending through the center segment 502 align vertically along the longitudinal axis 520. In another embodiment, holes 512 are offset from the longitudinal axis 520. In still other embodiments the holes 512 may have an offset 517 from the longitudinal axis 520 in either direction. For example, offset 517 from the longitudinal axis 520 can be from about 0.01″ to about 0.11″. More preferably, offset 517 can be from about 0.03″ to about 0.05″. The diameter of holes 512 is dictated by the purpose of the hole to be drilled. For example, to drill weight placement holes to fit a tungsten cylinder ⅜″ diameter, holes 512 would have a diameter of 0.406″ for use with a 25/64″ drill bit.

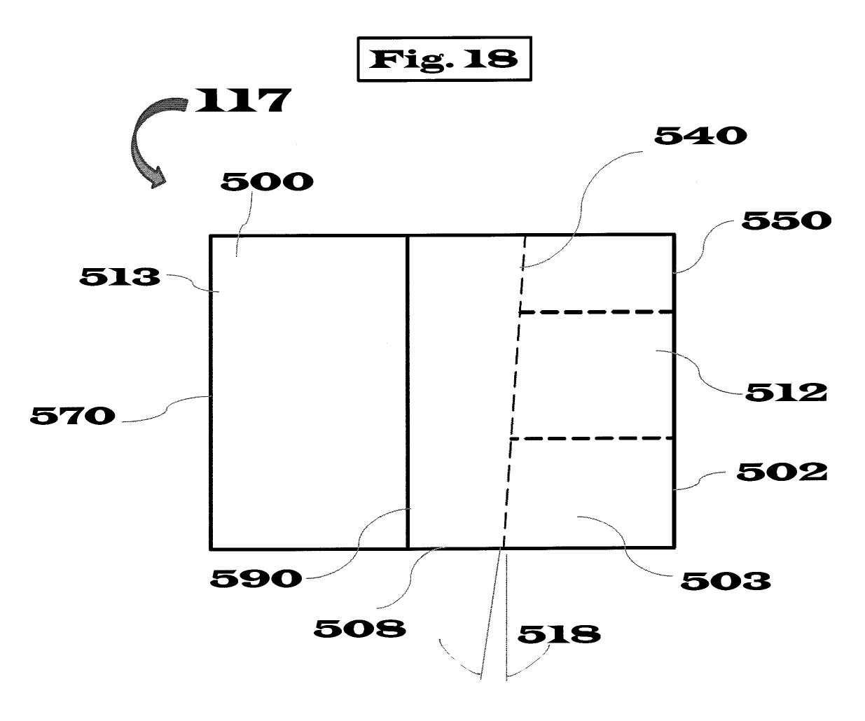

FIG. 18 is an end view of tool 117. As shown in FIG. 18, holes 512 of tool 117 are perpendicular with forward surface 550. Forward surface 550 is parallel with end 570. In some embodiments, rear surface 540 may also be parallel with forward surface 550 and end 570. In other embodiments, rear surface 540 is angled as indicated by angle 518. Angle 518 is an angle formed between rear surface 550 and a plane parallel with forward surface 540. Angle 518 of rear surface 540 can be about 1 degree, 2 degrees, 3 degrees, 4 degrees, 5 degrees, 6 degrees, 7 degrees, 8 degrees, 9 degrees or 10 degrees from a vertical plane, such as end 570. Preferably, angle 518 of rear surface 540 is within the range of 3 degrees to 5 degrees.

The tool and all embodiments may be used in connection with a model car block 50, finished model car 60, or any other model block.

FIG. 19 depicts tool 70 assembled to model car block 50. As shown, model car block 50 is inserted into first channel 10 with front surface 4 of tool 70 flush to the end of model car block 50. A hand held drill with a drill bit is used to engage holes 12 in tool 70 to create weight placement holes 30 in model car block 50. Weight placement holes 30 have a center axis 21. A clamp may engage surface 8 of tool 70 and a surface 55 of model car block 50 to hold tool 70 in place during drilling. When forward surface 4 engages an end 53 of model car block 50, the center axes 21 of weight placement holes 30 are parallel or perpendicular to any surface of model car block 50.

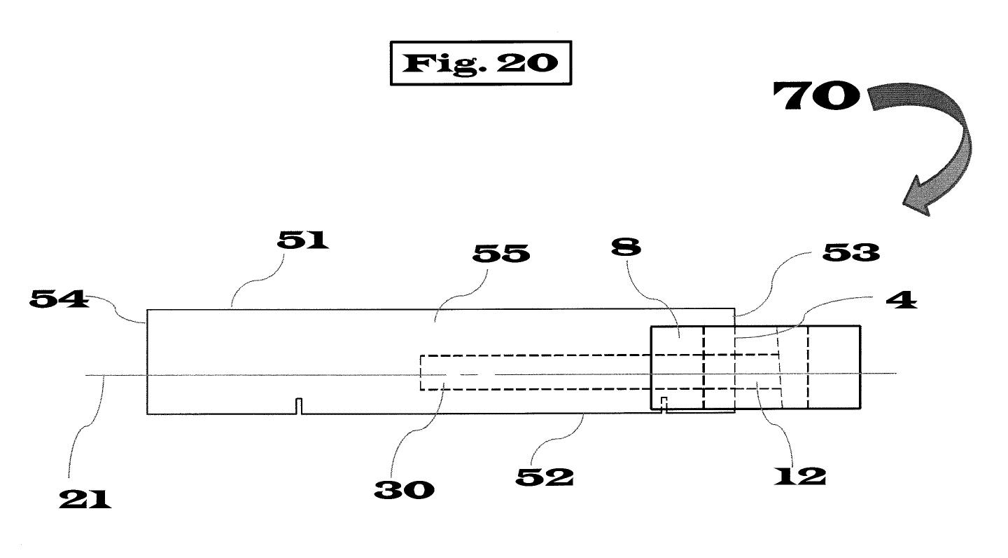

FIG. 20 depicts a side view of the assembly in FIG. 19. Weight placement holes 30 can be seen as drilled parallel to the top 51 and bottom 52 surfaces of model car block 50. Front surface 4 of tool 70 is engaged flush onto the end 53 surface of model car block 50. Weight placement holes 30 can be drilled to any depth desired by the builder.

FIG. 21 depicts tool 70 assembled to a finished model car 60. As shown, finished model car 60 is inserted into second channel 11 with rear surface 5 of tool 70 flush to the end 63 of finished model car 60. A hand held drill with a drill bit is used to engage holes 12 in tool 70 to create weight placement holes 30 in finished model car 60. A clamp may engage onto surface 8 of tool 70 and surface 65 of finished model car 60 to hold tool 70 in place during drilling. When forward surface 5 engages end 63 of finished model car 60, the center axes 21 of weight placement holes 30 are at an angle with a horizontal plane.

FIG. 22 depicts a side view of the assembly in FIG. 21. FIG. 22 depicts weight placement holes 30 drilled at an angle to bottom surface 62 of finished model car 60. In other embodiments, weight placement holes 30 are substantially parallel with top surface 67. Weight placement holes 30 can be drilled to any depth desired by the builder.

What is claimed is:

1. A tool for weight hole placement in a model car block comprising:
a first segment;
a second segment extending from the first segment, the second segment having first and second nonparallel surfaces, both the first and second nonparallel surfaces configured to engage the model car block; and
a plurality of spaced apart holes defined through the second segment for drilling weight placement holes into the model car block.

2. The tool of claim 1, further comprising a third segment connected to the second segment.

3. The tool of claim 2, wherein a first channel is formed between the first and third segments, and wherein the first channel is configured to closely receive a surface of the model car block.

4. The tool of claim 3, wherein a second channel is formed between the first and third segment, wherein the second channel is configured to closely receive a surface of the model car block.

5. The tool of claim 1, wherein weight placement holes drilled into the model car block through the spaced apart holes have parallel center axes.

6. The tool of claim 5, wherein the center axes of the weight placement holes are substantially parallel to an upper surface of a finished model car.

7. The tool of claim 5, wherein the center axes of the weight placement holes form an angle with a horizontal plane.

8. The tool of claim 1, wherein the holes are offset from a longitudinal centered axis centered on the second segment.

9. A tool for drilling at least one weight placement hole in a model car block comprising:
a bottom segment;
a center segment extending from the bottom segment, the center segment having at least one hole therethrough; and
a top segment, wherein a channel between the top and bottom segments is configured to closely receive the model car block and at the least one hole is positioned over a surface of the model car block in which a weight placement hole is to be drilled.

10. The tool of claim 9, wherein the surface of the model car block is one of a top, bottom, rear end or front end surfaces.

11. The tool of claim 9, the center segment comprising a forward face and a rear face both of which are configured to engage the surface of the model car block to be drilled.

12. The tool of claim 11, wherein a weight placement hole drilled into the model car block when the rear face engages the car block surface to be drilled is at a different angle than a weight placement hole drilled into the model car block when the forward surface engages the model car block surface to be drilled.

13. The tool of claim 9, wherein a central axis of the weight placement hole drilled through the tool and into the model car block will be substantially parallel to a finished upper surface of a model car made from the model car block.

14. The tool of claim 13, wherein the central axis of the weight placement hole is from about 3° to about 5° from a horizontal plane.

15. The tool of claim 9 comprising a plurality of spaced apart holes through which weight placement holes can be drilled.

16. The tool of claim 15, comprising three equally spaced apart holes.

17. The tool of claim 9, wherein a central axis of the weight placement hole drilled through the tool and into the model car block forms an angle with a horizontal plane.

18. The tool of claim 9, wherein the hole is offset from a longitudinal centered axis centered on the center segment.
